(19) United States
(12) Patent Application Publication
(10) Pub. No.: US 2025/0071765 A1
(43) Pub. Date: Feb. 27, 2025

(54) METHODS AND APPARATUS OF BEAM DETERMINATION OF PUSCH SCHEDULED OR ACTIVATED WITH DCI FORMAT 0_0 WHERE TWO COMMON BEAMS ARE INDICATED FOR UL TRANSMISSION

(71) Applicant: LENOVO (BEIJING) LIMITED, Beijing (CN)

(72) Inventors: Wei Ling, Beijing (CN); Yi Zhang, Beijing (CN); Chenxi Zhu, Fairfax, VA (US); Bingchao Liu, Beijing (CN); Lingling Xiao, Beijing (CN)

(21) Appl. No.: 18/723,347

(22) PCT Filed: Dec. 23, 2021
(86) PCT No.: PCT/CN2021/140922

§ 371 Date: Jun. 21, 2024

(51) Int. Cl. H04W 72/21; H04L 5/00

(52) U.S. Cl. CPC H04W 72/21; H04L 5/0044

(57) ABSTRACT

Methods and apparatus of beam determination of PUSCH scheduled or activated with DCI format 0_0 where two common beams are indicated for UL transmission are disclosed. The method includes: receiving, by a receiver. Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint; determining, by a processor, one or two TCI states selected from the two common TCI states for transmission of a Physical Uplink Shared Channel (PUSCH) scheduled or activated by DCI format 0_0; and transmitting, by a transmitter, the PUSCH with the selected TCI state.

### FIELD

The subject matter disclosed herein relates generally to wireless communication and more particularly relates to, but not limited to, methods and apparatus of beam determination of PUSCH scheduled or activated with DCI format 0_0 where two common beams are indicated for UL transmission.

### BACKGROUND

The following abbreviations and acronyms are herewith defined, at least some of which are referred to within the specification:

Third Generation Partnership Project (3GPP), 5th Generation (5G), New Radio (NR), 5G Node B (gNB), Long Term Evolution (LTE), LTE Advanced (LTE-A), E-UTRAN Node B (eNB), Universal Mobile Telecommunications System (UMTS), Worldwide Interoperability for Microwave Access (WiMAX), Evolved UMTS Terrestrial Radio Access Network (E-UTRAN), Wireless Local Area Networking (WLAN), Orthogonal Frequency Division Multiplexing (OFDM), Single-Carrier Frequency-Division Multiple Access (SC-FDMA), Downlink (DL), Uplink (UL), User Equipment (UE), Network Equipment (NE), Radio Access Technology (RAT), Receive or Receiver (RX), Transmit or Transmitter (TX), Hybrid Automatic Repeat Request (HARQ), Acknowledgement (ACK), Physical Downlink Control Channel (PDCCH), Physical Downlink Shared Channel (PDSCH), Physical Uplink Control Channel (PUCCH), Physical Uplink Shared Channel (PUSCH), Shared Channel (SCH), Uplink Shared Channel (UL-SCH), Bandwidth Part (BWP), Control Element (CE), Configured Grant (CG), Control Resource Set (CORESET), Cyclic redundancy check (CRC), Channel State Information (CSI), Downlink Control Information (DCI), Frequency Division Multiple Access (FDMA), Index/Identifier (ID), Media Access Control (MAC), Media Access Control-Control Element (MAC CE), Modulation Coding Scheme (MCS), New Data Indicator (NDI), Radio Network Temporary Identifier (RNTI), Radio Resource Control (RRC), Reference Signal (RS), Single Frequency Network (SFN), Transport Block (TB), Time-Division Multiplexing (TDM), Transmission and Reception Point (TRP), Uplink Control Information (UCI), Component Carrier (CC), Frequency Range 1 (FR1), Frequency Range 2 (FR2), Transmission Configuration Indication (TCI), Cell Radio Network Temporary Identifier (C-RNTI), Temporary C-RNTI (TC-RNTI), Technical Specification (TS), Configured Scheduling (CS), Quasi Co-Location (QCL).

In wireless communication, such as a Third Generation Partnership Project (3GPP) mobile network, a wireless mobile network may provide a seamless wireless communication service to a wireless communication terminal having mobility, i.e., user equipment (UE). The wireless mobile network may be formed of a plurality of base stations and a base station may perform wireless communication with the UEs.

The 5G New Radio (NR) is the latest in the series of 3GPP standards which supports very high data rate with lower latency compared to its predecessor LTE (4G) technology. Two types of frequency range (FR) are defined in 3GPP. Frequency of sub-6 GHz range (from 450 to 6000 MHz) is called FR1 and millimeter wave range (from 24.25 GHz to 52.6 GHz) is called FR2. The 5G NR supports both FR1 and FR2 frequency bands.

Enhancements on multi-TRP/panel transmission including improved reliability and robustness with both ideal and non-ideal backhaul between these TRPs (Transmit Receive Points) are studied. A TRP is an apparatus to transmit and receive signals, and is controlled by a gNB through the backhaul between the gNB and the TRP.

A joint common beam or a UL common beam may be indicated by a DCI or a MAC CE for determining the UL transmit filter of all PUSCHs and all PUCCHs. Conventionally, PUSCH scheduled or activated by DCI format 0_0 may only be transmitted with one beam which is the beam of a PUCCH resource with the lowest ID.

For multiple TRP cases, two joint or UL common beams may be indicated by a TCI codepoint in a DCI or be indicated by a codepoint in a MAC CE which only includes the only one codepoint. The transmit beam of the PUSCH scheduled or activated by DCI format 0_0 shall be determined.

### SUMMARY

Methods and apparatus of beam determination of PUSCH scheduled or activated with DCI format 0_0 where two common beams are indicated for UL transmission are disclosed.

According to a first aspect, there is provided a method, including: receiving, by a receiver, Downlink Control Information (DCI) comprising a Transmission Configuration Indication (TCI) field that indicates a TCI codepoint where two common TCI states are mapped, or a Media Access Control (MAC) Control Element (CE) that only activates two common TCI states which are mapped to a same TCI codepoint; determining, by a processor, one or two TCI states selected from the two common TCI states for transmission of a Physical Uplink Shared Channel (PUSCH) scheduled or activated by DCI format 0_0; and transmitting, by a transmitter, the PUSCH with the selected TCI state.

According to a second aspect, there is provided a method, including: transmitting, by a transmitter, Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint; determining, by a processor, one or two TCI states selected from the two common TCI states for transmission of a Physical Uplink Shared Channel (PUSCH) scheduled or activated by DCI format 0_0; and receiving, by a receiver, the PUSCH with the selected TCI state.

According to a third aspect, there is provided an apparatus, including: a receiver that receives Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint; a processor that determines one or two TCI states selected from the two common TCI states for transmission of a Physical Uplink Shared Channel (PUSCH) scheduled or activated by DCI format 0_0; and a transmitter that transmits the PUSCH with the selected TCI state.

According to a fourth aspect, there is provided an apparatus, including: a transmitter that transmits Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint; a processor that determines one or two TCI states selected from the two common TCI states for transmission of a Physical Uplink Shared Channel (PUSCH) scheduled or activated by DCI format 0_0; and a receiver that receives the PUSCH with the selected TCI state.

### BRIEF DESCRIPTION OF THE DRAWINGS

A more particular description of the embodiments will be rendered by reference to specific embodiments illustrated in the appended drawings. Given that these drawings depict only some embodiments and are not therefore considered to be limiting in scope, the embodiments will be described and explained with additional specificity and details through the use of the accompanying drawings, in which:

FIG. 1 is a schematic diagram illustrating a wireless communication system in accordance with some implementations of the present disclosure;

FIG. 2 is a schematic block diagram illustrating components of user equipment (UE) in accordance with some implementations of the present disclosure;

FIG. 3 is a schematic block diagram illustrating components of network equipment (NE) in accordance with some implementations of the present disclosure;

FIG. 4 is a schematic diagram illustrating an example of a UE-specific MAC CE that activates common TCI states in accordance with some implementations of the present disclosure;

FIG. 5 is a flow chart illustrating steps of beam determination of PUSCH scheduled or activated with DCI format 0_0 where two common beams are indicated for UL transmission by UE in accordance with some implementations of the present disclosure; and

FIG. 6 is a flow chart illustrating steps of beam determination of PUSCH scheduled or activated with DCI format 0_0 where two common beams are indicated for UL transmission by gNB or NE in accordance with some implementations of the present disclosure.

### DETAILED DESCRIPTION

As will be appreciated by one skilled in the art, aspects of the embodiments may be embodied as a system, an apparatus, a method, or a program product. Accordingly, embodiments may take the form of an all-hardware embodiment, an all-software embodiment (including firmware, resident software, micro-code, etc.) or an embodiment combining software and hardware aspects.

Furthermore, one or more embodiments may take the form of a program product embodied in one or more computer readable storage devices storing machine readable code, computer readable code, and/or program code, referred to hereafter as “code.” The storage devices may be tangible, non-transitory, and/or non-transmission.

Reference throughout this specification to “one embodiment,” “an embodiment,” “an example,” “some embodiments,” “some examples,” or similar language means that a particular feature, structure, or characteristic described is included in at least one embodiment or example. Thus, instances of the phrases “in one embodiment,” “in an example,” “in some embodiments,” and similar language throughout this specification may, but do not necessarily, all refer to the same embodiment(s). It may or may not include all the embodiments disclosed. Features, structures, elements, or characteristics described in connection with one or some embodiments are also applicable to other embodiments, unless expressly specified otherwise. The terms “including,” “comprising,” “having,” and variations thereof mean “including but not limited to,” unless expressly specified otherwise.

An enumerated listing of items does not imply that any or all of the items are mutually exclusive, unless expressly specified otherwise. The terms “a,” “an,” and “the” also refer to “one or more”, and similarly items expressed in plural form also include reference to one or multiple instances of the item, unless expressly specified otherwise.

Throughout the disclosure, the terms “first,” “second.” “third.” and etc. are all used as nomenclature only for references to relevant devices, components, procedural steps, and etc. without implying any spatial or chronological orders, unless expressly specified otherwise. For example, a “first device” and a “second device” may refer to two separately formed devices, or two parts or components of the same device. In some cases, for example, a “first device” and a “second device” may be identical, and may be named arbitrarily. Similarly, a “first step” of a method or process may be carried or performed after, or simultaneously with, a “second step.”

It should be understood that the term “and/or” as used herein refers to and includes any and all possible combinations of one or more of the associated listed items. For example, “A and/or B” may refer to any one of the following three combinations: existence of A only, existence of B only, and co-existence of both A and B. The character “/” generally indicates an “or” relationship of the associated items. This, however, may also include an “and” relationship of the associated items. For example, “A/B” means “A or B.” which may also include the co-existence of both A and B, unless the context indicates otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of various embodiments are described below with reference to schematic flowchart diagrams and/or schematic block diagrams of methods, apparatuses, systems, and program products. It will be understood that each block of the schematic flowchart diagrams and/or schematic block diagrams, as well as combinations of blocks in the schematic flowchart diagrams and/or schematic block diagrams, may be implemented by code. This code may be provided to a processor of a general-purpose computer, special purpose computer, or other programmable data processing apparatus to produce a machine, such that the instructions executed via the processor of the computer or other programmable data processing apparatus create a means for implementing the functions or acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function or act specified in the schematic flowchart diagrams and/or schematic block diagrams.

The schematic flowchart diagrams and/or schematic block diagrams in the Figures illustrate the architecture, functionality, and operation of possible implementations of different apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s). One skilled in the relevant art will recognize, however, that the flowchart diagrams need not necessarily be practiced in the sequence shown and are able to be practiced without one or more of the specific steps, or with other steps not shown.

It should also be noted that, in some alternative implementations, the functions noted in the identified blocks may occur out of the order noted in the Figures. For example, two blocks shown in succession may, in fact, be substantially executed in concurrence, or the blocks may sometimes be executed in reverse order, depending upon the functionality involved.

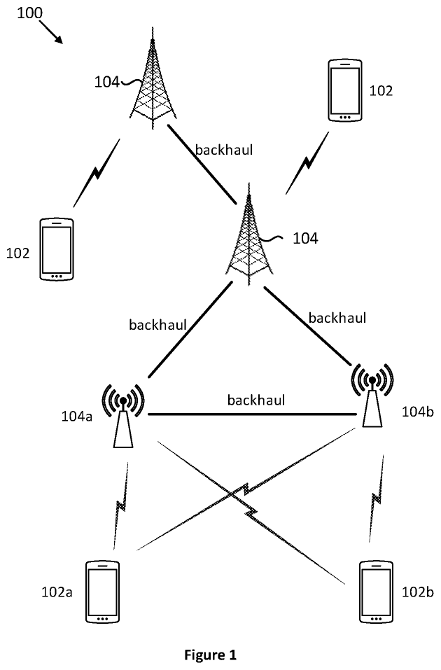

FIG. 1 is a schematic diagram illustrating a wireless communication system. It depicts an embodiment of a wireless communication system 100. In one embodiment, the wireless communication system 100 may include a user equipment (UE) 102 and a network equipment (NE) 104. Even though a specific number of UEs 102 and NEs 104 is depicted in FIG. 1, one skilled in the art will recognize that any number of UEs 102 and NEs 104 may be included in the wireless communication system 100.

The UEs 102 may be referred to as remote devices, remote units, subscriber units, mobiles, mobile stations, users, terminals, mobile terminals, fixed terminals, subscriber stations, user terminals, apparatus, devices, user device, or by other terminology used in the art.

In one embodiment, the UEs 102 may be autonomous sensor devices, alarm devices, actuator devices, remote control devices, or the like. In some other embodiments, the UEs 102 may include computing devices, such as desktop computers, laptop computers, personal digital assistants (PDAs), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the UEs 102 include wearable devices, such as smart watches, fitness bands, optical head-mounted displays, or the like. The UEs 102 may communicate directly with one or more of the NEs 104.

The NE 104 may also be referred to as a base station, an access point, an access terminal, a base, a Node-B, an eNB, a gNB, a Home Node-B, a relay node, an apparatus, a device, or by any other terminology used in the art. Throughout this specification, a reference to a base station may refer to any one of the above referenced types of the network equipment 104, such as the eNB and the gNB.

The NEs 104 may be distributed over a geographic region. The NE 104 is generally part of a radio access network that includes one or more controllers communicably coupled to one or more corresponding NEs 104. The radio access network is generally communicably coupled to one or more core networks, which may be coupled to other networks, like the Internet and public switched telephone networks. These and other elements of radio access and core networks are not illustrated, but are well known generally by those having ordinary skill in the art.

In one implementation, the wireless communication system 100 is compliant with a 3GPP 5G new radio (NR). In some implementations, the wireless communication system 100 is compliant with a 3GPP protocol, where the NEs 104 transmit using an OFDM modulation scheme on the DL and the UEs 102 transmit on the uplink (UL) using a SC-FDMA scheme or an OFDM scheme. More generally, however, the wireless communication system 100 may implement some other open or proprietary communication protocols, for example, WiMAX. The present disclosure is not intended to be limited to the implementation of any particular wireless communication system architecture or protocol.

The NE 104 may serve a number of UEs 102 within a serving area, for example, a cell (or a cell sector) or more cells via a wireless communication link. The NE 104 transmits DL communication signals to serve the UEs 102 in the time, frequency, and/or spatial domain.

Communication links are provided between the NE 104 and the UEs 102a, 102b, 102c, and 102d, which may be NR UL or DL communication links, for example. Some UEs 102 may simultaneously communicate with different Radio Access Technologies (RATs), such as NR and LTE. Direct or indirect communication link between two or more NEs 104 may be provided.

The NE 104 may also include one or more transmit receive points (TRPs) 104a. In some embodiments, the network equipment may be a gNB 104 that controls a number of TRPs 104a. In addition, there is a backhaul between two TRPs 104a. In some other embodiments, the network equipment may be a TRP 104a that is controlled by a gNB.

Communication links are provided between the NEs 104, 104a and the UEs 102, 102a, respectively, which, for example, may be NR UL/DL communication links. Some UEs 102, 102a may simultaneously communicate with different Radio Access Technologies (RATs), such as NR and LTE.

In some embodiments, the UE 102a may be able to communicate with two or more TRPs 104a that utilize a non-ideal or ideal backhaul, simultaneously. A TRP may be a transmission point of a gNB. Multiple beams may be used by the UE and/or TRP(s). The two or more TRPs may be TRPs of different gNBs, or a same gNB. That is, different TRPs may have the same Cell-ID or different Cell-IDs. The terms “TRP” and “transmitting-receiving identity” may be used interchangeably throughout the disclosure.

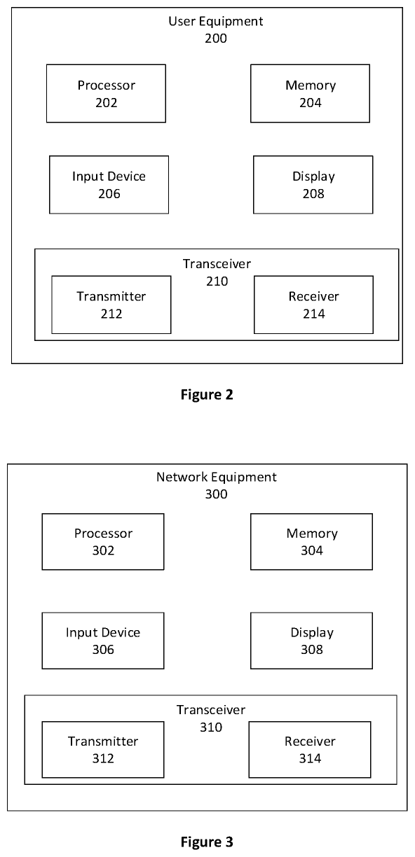

FIG. 2 is a schematic block diagram illustrating components of user equipment (UE) according to one embodiment. A UE 200 may include a processor 202, a memory 204, an input device 206, a display 208, and a transceiver 210. In some embodiments, the input device 206 and the display 208 are combined into a single device, such as a touchscreen. In certain embodiments, the UE 200 may not include any input device 206 and/or display 208. In various embodiments, the UE 200 may include one or more processors 202 and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (CPU), a graphics processing unit (GPU), an auxiliary processing unit, a field programmable gate array (FPGA), or similar programmable controller. In some embodiments, the processor 202 executes instructions stored in the memory 204 to perform the methods and routines described herein. The processor 202 is communicatively coupled to the memory 204 and the transceiver 210.

The memory 204, in one embodiment, is a computer readable storage medium. In some embodiments, the memory 204 includes volatile computer storage media. For example, the memory 204 may include a RAM, including dynamic RAM (DRAM), synchronous dynamic RAM (SDRAM), and/or static RAM (SRAM). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 stores data relating to trigger conditions for transmitting the measurement report to the network equipment. In some embodiments, the memory 204 also stores program code and related data.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display.

The display 208, in one embodiment, may include any known electronically controllable display or display device. The display 208 may be designed to output visual, audio, and/or haptic signals.

The transceiver 210, in one embodiment, is configured to communicate wirelessly with the network equipment. In certain embodiments, the transceiver 210 comprises a transmitter 212 and a receiver 214. The transmitter 212 is used to transmit UL communication signals to the network equipment and the receiver 214 is used to receive DL communication signals from the network equipment.

The transmitter 212 and the receiver 214 may be any suitable type of transmitters and receivers. Although only one transmitter 212 and one receiver 214 are illustrated, the transceiver 210 may have any suitable number of transmitters 212 and receivers 214. For example, in some embodiments, the UE 200 includes a plurality of the transmitter 212 and the receiver 214 pairs for communicating on a plurality of wireless networks and/or radio frequency bands, with each of the transmitter 212 and the receiver 214 pairs configured to communicate on a different wireless network and/or radio frequency band.

FIG. 3 is a schematic block diagram illustrating components of network equipment (NE) 300 according to one embodiment. The NE 300 may include a processor 302, a memory 304, an input device 306, a display 308, and a transceiver 310. As may be appreciated, the processor 302, the memory 304, the input device 306, the display 308, and the transceiver 310 may be similar to the processor 202, the memory 204, the input device 206, the display 208, and the transceiver 210 of the UE 200, respectively.

In some embodiments, the processor 302 controls the transceiver 310 to transmit DL signals or data to the UE 200. The processor 302 may also control the transceiver 310 to receive UL signals or data from the UE 200. In another example, the processor 302 may control the transceiver 310 to transmit DL signals containing various configuration data to the UE 200.

In some embodiments, the transceiver 310 comprises a transmitter 312 and a receiver 314. The transmitter 312 is used to transmit DL communication signals to the UE 200 and the receiver 314 is used to receive UL communication signals from the UE 200.

The transceiver 310 may communicate simultaneously with a plurality of UEs 200. For example, the transmitter 312 may transmit DL communication signals to the UE 200. As another example, the receiver 314 may simultaneously receive UL communication signals from the UE 200. The transmitter 312 and the receiver 314 may be any suitable type of transmitters and receivers. Although only one transmitter 312 and one receiver 314 are illustrated, the transceiver 310 may have any suitable number of transmitters 312 and receivers 314. For example, the NE 300 may serve multiple cells and/or cell sectors, where the transceiver 310 includes a transmitter 312 and a receiver 314 for each cell or cell sector.

Conventionally, in Release 15 or 16, PUSCH scheduled or activated by DCI format 0_0 may only be transmitted with one beam which is the beam of a PUCCH resource with the lowest ID, according to the UE procedure for transmitting the physical uplink shared channel as specified in TS38.214.

PUSCH transmission(s) can be dynamically scheduled by an UL grant in a DCI, or the transmission can correspond to a configured grant Type 1 or Type 2. The configured grant Type 1 PUSCH transmission is semi-statically configured to operate upon the reception of higher layer parameter of configuredGrantConfig including rrc-ConfiguredUplinkGrant without the detection of an UL grant in a DCI. The configured grant Type 2 PUSCH transmission is semi-persistently scheduled by an UL grant in a valid activation DCI according to TS 38.213 after the reception of higher layer parameter configuredGrantConfig not including rrc-ConfiguredUplinkGrant. If configuredGrantConfigToAddModList is configured, more than one configured grant configuration of configured grant Type 1 and/or configured grant Type 2 may be active at the same time on an active BWP of a serving cell.

For the PUSCH transmission corresponding to a Type 1 configured grant or a Type 2 configured grant activated by DCI format 0_0 or 0_1, the parameters applied for the transmission are provided by configuredGrantConfig except for dataScramblingIdentityPUSCH, txConfig, codebookSubset, maxRank, scaling of UCI-OnPUSCH, which are provided by pusch-Config. For the PUSCH transmission corresponding to a Type 2 configured grant activated by DCI format 0_2, the parameters applied for the transmission are provided by configuredGrantConfig except for dataScramblingIdentityPUSCH, txConfig, codebookSubsetDCI-0-2, maxRankForDCI-Format0-2, scaling of UCI-OnPUSCH, resourceAllocationType1GranularityDCI-0-2 provided by pusch-Config. If the UE is provided with transformPrecoder in configuredGrantConfig, the UE applies the higher layer parameter tp-pi2BPSK, if provided in pusch-Config, according to the procedure described in TS38.214 for the PUSCH transmission corresponding to a configured grant.

For the PUSCH retransmission scheduled by a PDCCH with CRC scrambled by CS-RNTI with NDI=1, the parameters in pusch-Config are applied for the PUSCH transmission except for p0-NominalWithoutGrant, p0-PUSCH-Alpha, powerControlLoopToUse, pathlossReferenceIndex described in TS 38.213, mcs-Table, mcs-TableTransformPrecoder described in TS38.214 and transformPrecoder described in TS38.214.

For a UE configured with two uplinks in a serving cell, PUSCH retransmission for a TB on the serving cell is not expected to be on a different uplink than the uplink used for the PUSCH initial transmission of that TB.

A UE shall upon detection of a PDCCH with a configured DCI format 0_0, 0_1 or 0_2 transmit the corresponding PUSCH as indicated by that DCI unless the UE does not generate a transport block as described in TS38.321. Upon detection of a DCI format 0_1 or 0_2 with ‘UL-SCH indicator’ set to ‘O’ and with a non-zero ‘CSI request’ where the associated reportQuantity in CSI-ReportConfig set to ‘none’ for all CSI report(s) triggered by ‘CSI request’ in this DCI format 0_1 or 0_2, the UE ignores all fields in this DCI except the ‘CSI request’ and the UE shall not transmit the corresponding PUSCH as indicated by this DCI format 0_1 or 0_2. When the UE is scheduled with multiple PUSCHs by a DCI, HARQ process ID indicated by this DCI applies to the first PUSCH, as described in TS38.214, HARQ process ID is then incremented by 1 for each subsequent PUSCH(s) in the scheduled order, with modulo 16 operation applied. For any HARQ process ID(s) in a given scheduled cell, the UE is not expected to transmit a PUSCH that overlaps in time with another PUSCH. Except for the case when a UE is configured by higher layer parameter PDCCH-Config that contains two different values of coresetPoolIndex in ControlResourceSet for the active BWP of a serving cell and PDCCHs that schedule two non-overlapping in time domain PUSCHs are associated to different ControlResourceSets having different values of coresetPoolIndex, for any two HARQ process IDs in a given scheduled cell, if the UE is scheduled to start a first PUSCH transmission starting in symbol j by a PDCCH ending in symbol i, the UE is not expected to be scheduled to transmit a PUSCH starting earlier than the end of the first PUSCH by a PDCCH that ends later than symbol i. The UE is not expected to be scheduled to transmit another PUSCH by a DCI format 0_0 with CRC scrambled by TC-RNTI, for a given HARQ process with the DCI received before the end of the expected transmission of the last PUSCH for that HARQ process if the latter is scheduled by a DCI format 0_0 with CRC scrambled by TC-RNTI or by an UL grant in RA Response. The UE is not expected to be scheduled to transmit another PUSCH by DCI format 0_0, 0_1 or 0_2 scrambled by C-RNTI, CS-RNTI or MCS-C-RNTI for a given HARQ process with the DCI received before the end of the expected transmission of the last PUSCH for that HARQ process if the latter is scheduled by a DCI with CRC scrambled by C-RNTI, CS-RNTI or MCS-C-RNTI.

If a UE is configured by higher layer parameter PDCCH-Config that contains two different values of coresetPoolIndex in ControlResourceSet for the active BWP of a serving cell and PDCCHs that schedule two non-overlapping in time domain PUSCHs are associated to different ControlResourceSets having different values of coresetPoolIndex, for any two HARQ process IDs in a given scheduled cell, if the UE is scheduled to start a first PUSCH transmission starting in symbol j by a PDCCH associated with a value of coresetPoolIndex ending in symbol i, the UE can be scheduled to transmit a PUSCH starting earlier than the end of the first PUSCH by a PDCCH associated with a different value of coresetPoolIndex that ends later than symbol i.

A UE is not expected to be scheduled by a PDCCH ending in symbol i to transmit a PUSCH on a given serving cell overlapping in time with a transmission occasion, where the UE is allowed to transmit a PUSCH with configured grant according to TS38.321, starting in a symbol j on the same serving cell if the end of symbol i is not at least N₂ symbols before the beginning of symbol j. The value N₂ in symbols is determined according to the UE processing capability defined in TS38.214, and N₂ and the symbol duration are based on the minimum of the subcarrier spacing corresponding to the PUSCH with configured grant and the subcarrier spacing of the PDCCH scheduling the PUSCH.

If a UE receives an ACK for a given HARQ process in CG-DFI in a PDCCH ending in symbol i to terminate a transport block repetition in a PUSCH transmission with a configured grant on a given serving cell with the same HARQ process after symbol i, the UE is expected to terminate the repetition of the transport block in a PUSCH transmission starting from a symbol j if the gap between the end of PDCCH of symbol i and the start of the PUSCH transmission in symbol j is equal to or more than N2 symbols. The value N2 in symbols is determined according to the UE processing capability defined in TS38.214, and N2 and the symbol duration are based on the minimum of the subcarrier spacing corresponding to the PUSCH and the subcarrier spacing of the PDCCH indicating CG-DFI.

A UE is not expected to be scheduled by a PDCCH ending in symbol i to transmit a PUSCH on a given serving cell for a given HARQ process, if there is a transmission occasion where the UE is allowed to transmit a PUSCH with configured grant according to TS38.321 with the same HARQ process on the same serving cell starting in a symbol j after symbol i, and if the gap between the end of PDCCH and the beginning of symbol j is less than N₂ symbols. The value N₂ in symbols is determined according to the UE processing capability defined in TS38.214, and N₂ and the symbol duration are based on the minimum of the subcarrier spacing corresponding to the PUSCH with configured grant and the subcarrier spacing of the PDCCH scheduling the PUSCH.

For PUSCH scheduled by DCI format 0_0 on a cell, the UE shall transmit PUSCH according to the spatial relation, if applicable, corresponding to the dedicated PUCCH resource with the lowest ID within the active UL BWP of the cell, as described in TS 38.213.

For PUSCH scheduled by DCI format 0_0 on a cell and if the higher layer parameter enableDefaultBeamPL-ForPUSCH0-0 is set ‘enabled’, the UE is not configured with PUCCH resources on the active UL BWP and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell.

For PUSCH scheduled by DCI format 0_0 on a cell and if the higher layer parameter enableDefaultBeamPL-ForPUSCH0-0 is set ‘enabled’, the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS configured with qcl-Type set to ‘typeD’ corresponding to the QCL assumption of the CORESET with the lowest ID on the active DL BWP of the cell in case CORESET(s) are configured on the cell.

For uplink, 16 HARQ processes per cell is supported by the UE.

It is agreed that in common beam mode of Release 17, the beam of all PUSCH is determined according to the joint or UL common TCI state which is indicated by a DCI or a MAC CE, with a unified TCI framework. Joint TCI for DL and UL based on and analogous to Release15 or 16 DL TCI framework shall be supported. The term “TCI” at least comprises a TCI state that includes at least one source RS to provide a reference (UE assumption) for determining QCL and/or spatial filter.

The source reference signal(s) in M TCIs provide common QCL information at least for UE-dedicated reception on PDSCH and all or subset of CORESETs in a CC, with a working assumption of selecting between M=1 and M>=1.

The source reference signal(s) in N TCIs provide a reference for determining common UL TX spatial filter(s) at least for dynamic-grant/configured-grant based PUSCH, all or subset of dedicated PUCCH resources in a CC, with a working assumption of selecting between N=1 and N>=1.

On Release 17 unified TCI, there is no consensus in supporting additional (M,N) values other than (M,N)=(1,1). Only one joint or UL common TCI state can be indicated for UL transmission.

In Release 18, it may be further studied that multiple joint or UL common TCI states can be indicated for multiple TRPs. However, as specified in TS38.214, PUSCH scheduled or activated by DCI format 0_0 can only be transmitted by one beam. Although in Release 17, PUSCH with repetition can be transmitted by up to 2 beams in TDM (time domain multiplexing) manner, however, PUSCH scheduled or activated by DCI format 0_0 cannot support repetition.

In addition, multiple-panel simultaneous transmission may be supported in Release 18 where multiple beams can be transmitted simultaneously. SFN (single frame network) scheme may be configured for UL transmission considering that SFN scheme is supported for DL in Release 17 already where SFN scheme means that each layer of a UL transmission is transmitted with multiple beams towards multiple TRPs here.

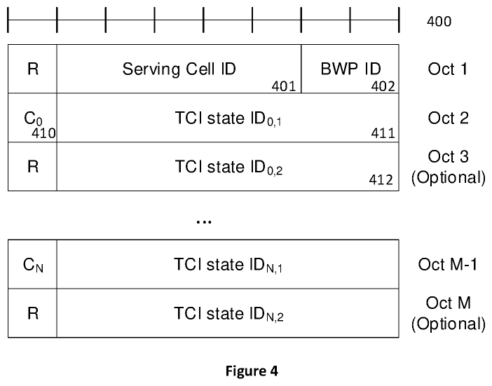

FIG. 4 is a schematic diagram illustrating an example of a UE-specific MAC CE that activates common TCI states in accordance with some implementations of the present disclosure. In this example, the MAC CE 400 has a variable size consisting of following fields:
Serving Cell ID 401: This field indicates the identity of the Serving Cell for which the MAC CE applies. The length of the field is 5 bits;
BWP ID 402: This field indicates a DL BWP for which the MAC CE applies as the codepoint of the DCI bandwidth part indicator field as specified in TS 38.212. The length of the BWP ID field is 2 bits;
Cᵢ 410: This field indicates whether the octet containing TCI state ID_{i,2} is present. If this field is set to “1”, the octet containing TCI state ID_{i,2} is present. If this field is set to “0”, the octet containing TCI state ID_{i,2} is not present;
TCI state ID_{i,j} 411, 412: This field indicates the TCI state identified by TCI-StateId as specified in TS 38.331, where i is the index of the codepoint of the DCI Transmission configuration indication field as specified in TS 38.212 and TCI state ID_{i,j} denotes the j^{th} TCI state indicated for the i^{th} codepoint in the DCI Transmission Configuration Indication field. The TCI codepoint to which the TCI States are mapped is determined by its ordinal position among all the TCI codepoints with sets of TCI state ID_{i,j} fields, i.e. the first TCI codepoint with TCI state ID_{0,1} 411 and TCI state ID_{0,2} 412 shall be mapped to the codepoint value 0, the second TCI codepoint with TCI state ID_{1,1} and TCI state ID_{1,2} shall be mapped to the codepoint value 1 and so on. The TCI state ID_{i,2} is optional based on the indication of the Cᵢ field. The maximum number of activated TCI codepoint is 8 and the maximum number of TCI states mapped to a TCI codepoint is 2.
R: Reserved bit, set to “0”.

In some examples, the MAC CE 400 may activate multiple TCI codepoints, and each TCI codepoint is mapped with two common TCI states 411 and 412. The Downlink Control Information (DCI) comprises a Transmission Configuration Indication (TCI) field that indicates a TCI codepoint where two common TCI states are mapped.

In some other examples, the MAC CE 400 may activate only one codepoint, that is mapped with two common TCI states 411 and 412. Namely, the MAC CE activates only two common TCI states which are mapped to a same TCI codepoint. In this case, it may not be necessary to be indicated in the DCI. The common TCI states are indicated by a MAC CE.

Each of the two common TCI states may be a joint common TCI state indicating a joint common beam for UL and downlink (DL) transmissions, or an uplink (UL) common TCI state indicating a UL common beam for UL transmissions.

The two common TCI states comprise a first TCI state 411 that is mandatory in a UE-specific Media Access Control (MAC) Control Element (CE), and a second TCI 412 state that is optional in the UE-specific MAC CE.

Considering that SFN scheme may be configured for PUSCH transmission if UE is capable to transmit with multiple panels simultaneously according to its reported capability, the following cases are described as examples of determining a beam or beams for PUSCH scheduled or activated by DCI format 0_0 when two joint or UL TCI states indicated by a DCI field are applicable.

In a first case, SFN scheme is not configured in PUSCH-Config.

When two joint or UL common TCI states are applicable in the transmission occasion of a PUSCH scheduled or activated by DCI format 0_0, the first joint or UL common TCI states indicated in a TCI codepoint of a DCI, or the first joint or UL common TCI states activated in a MAC CE which only activates one codepoint mapping to two common TCI states, which indicates the two joint or UL common TCI states is used for the transmission of the PUSCH. In this solution (which may be referred to as solution 1), only the first joint or UL common TCI state is determined for the PUSCH scheduled or activated by DCI format 0_0.

For example, where SFN scheme is not configured in PUSCH-Config, a TCI field in a DCI indicates a codepoint where two joint or UL common TCI states are mapped. The first indicated TCI state is TCI state 1 and the second indicated TCI state is TCI state 2. The two indicated TCI states are applicable from slot n. And a PUSCH scheduled or activated by DCI format 0_0 is transmitted in slot n+k (k>=0), then the transmit spatial filter of the PUSCH is according to the first joint or UL common TCI state which is TCI state 1.

In a second case, SFN scheme is configured in PUSCH-Config, and PUSCH scheduled or activated with DCI format 0_0 does not support SFN scheme.

The same solution as the first case may be used. When two joint or UL common TCI states are applicable in the transmission occasion of a PUSCH scheduled or activated by DCI format 0_0, the first joint or UL common TCI states indicated in a TCI codepoint of a DCI which indicates the two joint or UL common TCI states or the first joint or UL common TCI states activated in a MAC CE which only activates one codepoint mapping to two common TCI states is used for the transmission of the PUSCH.

In a third case, SFN scheme is configured in PUSCH-Config, and PUSCH scheduled or activated with DCI format 0_0 supports SFN scheme.

When two joint or UL common TCI states are applicable in the transmission occasion of a PUSCH scheduled or activated by DCI format 0_0, both of the two joint or UL common TCI states are used for the transmission of the PUSCH. This solution may be referred to as solution 2.

For example, SFN scheme is configured in PUSCH-Config and SFN scheme is also supported for PUSCH scheduled or activated by DCI format 0_0. A TCI field in a DCI indicates a codepoint where two joint or UL common TCI states are mapped where the first indicated TCI state is TCI state 1 and the second indicated TCI state is TCI state 2. The two indicated TCI states are applicable from slot n. And a PUSCH scheduled or activated by DCI format 0_0 is transmitted in slot n+k (k>=0), then the transmit spatial filters of the PUSCH are according to the two applicable joint or UL common TCI states which are TCI state 1 and TCI state 2.

When SFN scheme is configured in PUSCH-Config, whether SFN scheme is supported for PUSCH scheduled or activated by DCI format 0_0 may be fixed in specification or may be configured by RRC.

For the case that whether SFN scheme is supported for PUSCH scheduled or activated by DCI format 0_0 is fixed in specification: if the 3GPP specification specifies that SFN scheme is not be supported for any PUSCH scheduled or activated by DCI format 0_0, then solution 1 is always applied for PUSCH scheduled or activated with DCI format 0_0; if the 3GPP specification specifies that SFN scheme is supported for each PUSCH scheduled or activated by DCI format 0_0, then solution 2 is always applied for PUSCH scheduled or activated with DCI format 0_0.

For the case that whether SFN scheme is supported for PUSCH scheduled or activated by DCI format 0_0 is configured by RRC: if it is configured by RRC that SFN scheme is not supported for a PUSCH scheduled or activated by DCI format 0_0, then solution 1 is applied for the PUSCH scheduled or activated with DCI format 0_0; if it is configured that SFN scheme is supported for a PUSCH scheduled or activated by DCI format 0_0, then solution 2 is applied for the PUSCH scheduled or activated with DCI format 0_0.

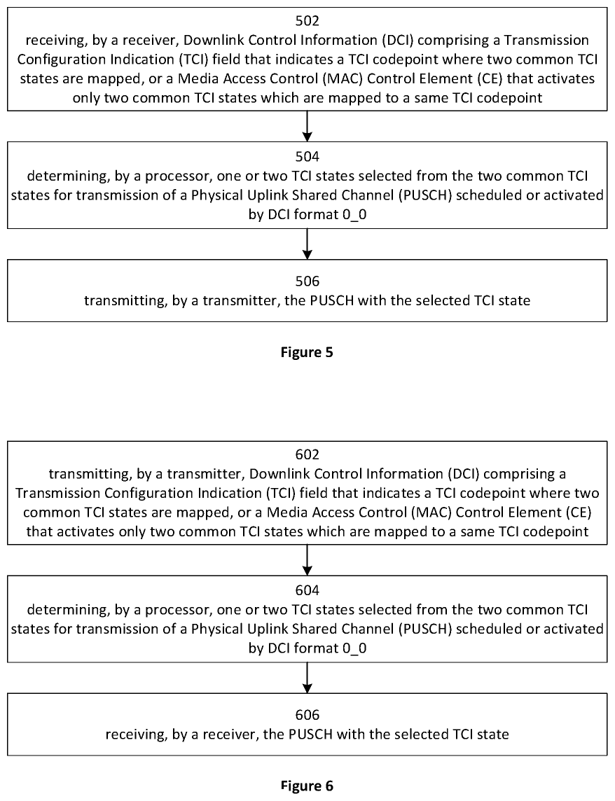

FIG. 5 is a flow chart illustrating steps of beam determination of PUSCH scheduled or activated with DCI format 0_0 where two common beams are indicated for UL transmission by UE 200 in accordance with some implementations of the present disclosure.

At step 502, the receiver 214 of UE 200 receives Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint.

At step 504, the processor 202 of UE 200 determines one or two TCI states selected from the two common TCI states for transmission of a Physical Uplink Shared Channel (PUSCH) scheduled or activated by DCI format 0_0.

At step 506, the transmitter 212 of UE 200 transmits the PUSCH with the selected TCI state.

FIG. 6 is a flow chart illustrating steps of beam determination of PUSCH scheduled or activated with DCI format 0_0 where two common beams are indicated for UL transmission by gNB or NE 300 in accordance with some implementations of the present disclosure.

At step 602, the transmitter 312 of NE 300 transmits Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint.

At step 604, the processor 302 of NE 300 determines one or two TCI states selected from the two common TCI states for transmission of a Physical Uplink Shared Channel (PUSCH) scheduled or activated by DCI format 0_0.

At step 606, the receiver 314 of NE 300 receives the PUSCH with the selected TCI state.

In one aspect, some items as examples of the disclosure concerning a method of a UE or remote device may be summarized as follows:

1. A method, comprising:
receiving, by a receiver, Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint;
determining, by a processor, one or two TCI states selected from the two common TCI states for transmission of a Physical Uplink Shared Channel (PUSCH) scheduled or activated by DCI format 0_0; and
transmitting, by a transmitter, the PUSCH with the selected TCI state.

2. The method of item 1, wherein the selected TCI state is determined based on whether Single Frequency Network (SFN) scheme is configured in PUSCH-Config.

3. The method of item 2, wherein upon determining that SFN scheme is configured in PUSCH-Config, and SFN scheme is supported by the PUSCH scheduled or activated by DCI format 0_0, it is determined that the selected TCI state comprises both of the two common TCI states.

4. The method of item 1, wherein the selected TCI state is one of the two common TCI states.

5. The method of item 4, wherein the two common TCI states comprise a first TCI state that is mandatory in a UE-specific Media Access Control (MAC) Control Element (CE), and a second TCI state that is optional in the UE-specific MAC CE; and it is determined that the selected TCI state is the first TCI state.

6. The method of item 2, wherein upon determining that SFN scheme is configured in PUSCH-Config, it is assumed that SFN scheme is supported by the PUSCH scheduled or activated by DCI format 0_0.

7. The method of item 2, wherein upon determining that SFN scheme is configured in PUSCH-Config, the processor further determines whether SFN scheme is supported by the PUSCH scheduled or activated by DCI format 0_0 based on Radio Resource Control (RRC) configuration.

In another aspect, some items as examples of the disclosure concerning a method of a NE or gNB may be summarized as follows:

8. A method, comprising:
transmitting, by a transmitter, Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint;
determining, by a processor, one or two TCI states selected from the two common TCI states for transmission of a Physical Uplink Shared Channel (PUSCH) scheduled or activated by DCI format 0_0; and
receiving, by a receiver, the PUSCH with the selected TCI state.

9. The method of item 8, wherein the selected TCI state is determined based on whether Single Frequency Network (SFN) scheme is configured in PUSCH-Config.

10. The method of item 9, wherein upon determining that SFN scheme is configured in PUSCH-Config, and SFN scheme is supported by the PUSCH scheduled or activated by DCI format 0_0, it is determined that the selected TCI state comprises both of the two common TCI states.

11. The method of item 8, wherein the selected TCI state is one of the two common TCI states.

12. The method of item 11, wherein the two common TCI states comprise a first TCI state that is mandatory in a UE-specific Media Access Control (MAC) Control Element (CE), and a second TCI state that is optional in the UE-specific MAC CE; and it is determined that the selected TCI state is the first TCI state.

13. The method of item 9, wherein upon determining that SFN scheme is configured in PUSCH-Config, it is assumed that SFN scheme is supported by the PUSCH scheduled or activated by DCI format 0_0.

14. The method of item 9, wherein upon determining that SFN scheme is configured in PUSCH-Config, the processor further determines whether SFN scheme is supported by the PUSCH scheduled or activated by DCI format 0_0 based on Radio Resource Control (RRC) configuration.

In a further aspect, some items as examples of the disclosure concerning a UE or remote device may be summarized as follows:

15. An apparatus, comprising:
a receiver that receives Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint;
a processor that determines one or two TCI states selected from the two common TCI states for transmission of a Physical Uplink Shared Channel (PUSCH) scheduled or activated by DCI format 0_0; and
a transmitter that transmits the PUSCH with the selected TCI state.

16. The apparatus of item 15, wherein the selected TCI state is determined based on whether Single Frequency Network (SFN) scheme is configured in PUSCH-Config.

17. The apparatus of item 16, wherein upon determining that SFN scheme is configured in PUSCH-Config, and SFN scheme is supported by the PUSCH scheduled or activated by DCI format 0_0, it is determined that the selected TCI state comprises both of the two common TCI states.

18. The apparatus of item 15, wherein the selected TCI state is one of the two common TCI states.

19. The apparatus of item 18, wherein the two common TCI states comprise a first TCI state that is mandatory in a UE-specific Media Access Control (MAC) Control Element (CE), and a second TCI state that is optional in the UE-specific MAC CE; and it is determined that the selected TCI state is the first TCI state.

20. The apparatus of item 16, wherein upon determining that SFN scheme is configured in PUSCH-Config, it is assumed that SFN scheme is supported by the PUSCH scheduled or activated by DCI format 0_0.

21. The apparatus of item 16, wherein upon determining that SFN scheme is configured in PUSCH-Config, the processor further determines whether SFN scheme is supported by the PUSCH scheduled or activated by DCI format 0_0 based on Radio Resource Control (RRC) configuration.

In a yet further aspect, some items as examples of the disclosure concerning a NE or gNB may be summarized as follows:

22. An apparatus, comprising:
a transmitter that transmits Downlink Control Information (DCI) comprising a Transmission Configuration Indication (TCI) field that indicates a TCI codepoint where two common TCI states are mapped, or a Media Access Control (MAC) Control Element (CE) that activates only two common TCI states which are mapped to a same TCI codepoint;
a processor that determines one or two TCI states selected from the two common TCI states for transmission of a Physical Uplink Shared Channel (PUSCH) scheduled or activated by DCI format 0_0; and a receiver that receives the PUSCH with the selected TCI state.

23. The apparatus of item 22, wherein the selected TCI state is determined based on whether Single Frequency Network (SFN) scheme is configured in PUSCH-Config.

24. The apparatus of item 23, wherein upon determining that SFN scheme is configured in PUSCH-Config, and SFN scheme is supported by the PUSCH scheduled or activated by DCI format 0_0, it is determined that the selected TCI state comprises both of the two common TCI states.

25. The apparatus of item 22, wherein the selected TCI state is one of the two common TCI states.

26. The apparatus of item 25, wherein the two common TCI states comprise a first TCI state that is mandatory in a UE-specific Media Access Control (MAC) Control Element (CE), and a second TCI state that is optional in the UE-specific MAC CE; and it is determined that the selected TCI state is the first TCI state.

27. The apparatus of item 23, wherein upon determining that SFN scheme is configured in PUSCH-Config, it is assumed that SFN scheme is supported by the PUSCH scheduled or activated by DCI format 0_0.

28. The apparatus of item 23, wherein upon determining that SFN scheme is configured in PUSCH-Config, the processor further determines whether SFN scheme is supported by the PUSCH scheduled or activated by DCI format 0_0 based on Radio Resource Control (RRC) configuration.

Various embodiments and/or examples are disclosed to provide exemplary and explanatory information to enable a person of ordinary skill in the art to put the disclosure into practice. Features or components disclosed with reference to one embodiment or example are also applicable to all embodiments or examples unless specifically indicated otherwise.

Embodiments may be practiced in other specific forms. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

1. A method performed by a user equipment (UE), comprising:
receiving, Downlink Control Information (DCI) comprising a Transmission Configuration Indication (TCI) field that indicates a TCI codepoint where two common TCI states are indicated, or a Media Access Control (MAC) Control Element (CE) that activates only two common TCI states which are mapped to a same TCI codepoint;
determining a TCI state selected from the two common TCI states for transmission of a Physical Uplink Shared Channel (PUSCH) scheduled or activated by DCI format 0_0; and
transmitting the PUSCH with the selected TCI state.

2. The method of claim 1, wherein the selected TCI state is determined based on whether Single Frequency Network (SFN) scheme is configured in PUSCH-Config.

3. The method of claim 2, wherein upon determining that SFN scheme is configured in PUSCH-Config, and SFN scheme is supported by the PUSCH scheduled or activated by DCI format 0_0, it is determined that the selected TCI state comprises both of the two common TCI states.

4. The method of claim 1, wherein the selected TCI state is one of the two common TCI states.

5. The method of claim 4, wherein the selected TCI state is a first TCI state of the two common TCI states.

6. The method of claim 2, wherein upon determining that SFN scheme is configured in PUSCH-Config, it is assumed that SFN scheme is supported by the PUSCH scheduled or activated by DCI format 0_0.

7. The method of claim 2, wherein upon determining that SFN scheme is configured in PUSCH-Config, the method determines whether SFN scheme is supported by the PUSCH scheduled or activated by DCI format 0_0 based on Radio Resource Control (RRC) configuration.

8. A method performed by a base station, the method comprising:
transmitting Downlink Control Information (DCI) comprising a Transmission Configuration Indication (TCI) field that indicates a TCI codepoint where two common TCI states are indicated, or a Media Access Control (MAC) Control Element (CE) that activates only two common TCI states which are mapped to a same TCI codepoint;
determining a TCI state selected from the two common TCI states for transmission of a Physical Uplink Shared Channel (PUSCH) scheduled or activated by DCI format 0_0; and
receiving the PUSCH with the selected TCI state.

9. The method of claim 8, wherein the selected TCI state is determined based on whether Single Frequency Network (SFN) scheme is configured in PUSCH-Config.

10. The method of claim 9, wherein upon determining that SFN scheme is configured in PUSCH-Config, and SFN scheme is supported by the PUSCH scheduled or activated by DCI format 0_0, it is determined that the selected TCI state comprises both of the two common TCI states.

11. The method of claim 8, wherein the selected TCI state is one of the two common TCI states.

12. The method of claim 11, wherein the selected TCI state is a first TCI state of the two common TCI states.

13. The method of claim 9, wherein upon determining that SFN scheme is configured in PUSCH-Config, it is assumed that SFN scheme is supported by the PUSCH scheduled or activated by DCI format 0_0.

14. The method of claim 9, wherein upon determining that SFN scheme is configured in PUSCH-Config, the method determines whether SFN scheme is supported by the PUSCH scheduled or activated by DCI format 0_0 based on Radio Resource Control (RRC) configuration.

15. A user equipment (UE), comprising:
at least one memory; and
at least one processor coupled with the at least one memory and configured to cause the UE to:
receive Downlink Control Information (DCI) comprising a Transmission Configuration Indication (TCI) field that indicates a TCI codepoint where two common TCI states are indicated, or a Media Access Control (MAC) Control Element (CE) that activates only two common TCI states which are mapped to a same TCI codepoint;
determine a TCI state selected from the two common TCI states for transmission of a Physical Uplink Shared Channel (PUSCH) scheduled or activated by DCI format 0_0; and
transmit the PUSCH with the selected TCI state.

16. The UE of claim 15, wherein the selected TCI state is determined based on whether Single Frequency Network (SFN) scheme is configured in PUSCH-Config.

17. The UE of claim 16, wherein upon determining that SFN scheme is configured in PUSCH-Config, and SFN scheme is supported by the PUSCH scheduled or activated by DCI format 0_0, it is determined that the selected TCI state comprises both of the two common TCI states.

18. The UE of claim 15, wherein the selected TCI state is one of the two common TCI states.

19. The UE of claim 18, wherein the two common TCI states comprise a first TCI state that is mandatory in a UE-specific Media Access Control (MAC) Control Element (CE), and a second TCI state that is optional in the UE-specific MAC CE; and it is determined that the selected TCI state is the first TCI state.

20. A processor for wireless communication, comprising:
at least one controller coupled with at least one memory and configured to cause the processor to:
receive Downlink Control Information (DCI) comprising a Transmission Configuration Indication (TCI) field that indicates a TCI codepoint where two common TCI states are indicated, or a Media Access Control (MAC) Control Element (CE) that activates only two common TCI states which are mapped to a same TCI codepoint;
determine a TCI state selected from the two common TCI states for transmission of a Physical Uplink Shared Channel (PUSCH) scheduled or activated by DCI format 0_0; and
transmit the PUSCH with the selected TCI state.
